(19) United States
(12) Patent Application Publication
(10) Pub. No.: US 2004/0133925 A1
(43) Pub. Date: Jul. 8, 2004

(54) Method for transmitting information stream corresponding transmission system transmitter receiver and computer product

(76) Inventors: Guido Franceschini, Torino (IT); Mauro Quaglia, Torino (IT); Andrea Varesio, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/479,496

(22) PCT Filed: May 30, 2002
(86) PCT No.: PCT/IT02/00346

(30) Foreign Application Priority Data
Jun. 1, 2001 (IT) TO2001A000525

(51) Int. Cl. H04N 7/16

(52) U.S. Cl. 725/135; 725/136

(57) ABSTRACT

An information stream with video (V), audio (A) and data (D) components assembled in access units (Vtn, Atn, Dtn) with associated respective meta-information is transmitted on a set of communication channels (Cj), such as different lines of a mobile communication network. The stream is arranged in packets each of which contains at least a segment of access unit and a header (H). The header (H) in question comprises a first set of fields (HS), which represents the meta-information associated to the related access unit(s), and a second set of fields (HG), comprising general validity fields, independent from the information stream. Typically, these are fields that convey the following information: number (PN) of the packet in the order of transmission, identifier (CH) of the channel that carries a particular stream, length (L) of the data packet as well as check, for instance of the checksum type (CK). Preferably, the latter field is related to all the data of the header (H), except the check field itself.

### TECHNICAL FIELD

The present invention relates to transmission techniques and it was developed with particular attention to its possible application to audio-visual or multimedia communication systems.

The invention tackles the problem of the possible allocation over multiple channels of data streams such as audio and video streams to be presented in synchronised fashion to the receiving terminal. The invention is especially aimed at meeting the requirement of transmitting information streams of this nature on a certain number of channels of a communication network (such as a packet switched network and/or a mobile communication network) under conditions in which, the transmission capacity of the individual channel not being sufficient to meet the transmission requirements, it is necessary to provide for transmission over multiple channels, under conditions in which the number of the aforesaid channels can also vary over time according to transmission requirements.

### BACKGROUND ART

Methods are known in the prior art which allow to associate information to each packet that transports multimedia data: reference can be made, for instance, to the RTP header (IETF RFC 1889), to the header PES (ISO/IEC 13818-1) or else to the header SL (ISO/IEC 14496-1). In particular, the last header mentioned allows a high degree of configurability and hence enables to optimise bit consumption in the various cases.

Also known are solutions that allow to multiplex different data streams: again, by way of example, reference can be made to the solution known as MPEG-A Flexmux (ISO/IEC 14496-1), which uses a header containing eight bits to identify the data stream and eight bits to indicate the length of the packet.

Lastly, at least for particular applications, solutions are known that allow to allocate a sequence of packets over multiple transmission channels: a technique of this kind is used in some cases to manage transmission on two ISDN B channels.

The direct application of such solutions to the context outlined above, however, can hardly be proposed: the quantity of control information necessary to assure the correct aggregation of the information stream in transmission and a corresponding accurate de-aggregation in reception (the terms “aggregation” and “de-aggregation” are used herein with their most general meaning) would end up having a significant percent weight relative to the useful information (payload) that is transmitted. All with an extremely inefficient use of available transmission resources, already reduced if referred to the streams to be transmitted.

### DISCLOSURE OF THE INVENTION

The aim of the present invention is to provide an enhanced solution with respect to the solutions of the prior art, especially in regard to the exploitation of the bandwidth available for transmission.

According to the present invention, said aim is achieved thanks to a transmission method having the characteristics specifically set out in the claims that follow. The invention also refers to the related system, to the transmitter and to the receiver that correspond thereto, as well as to the corresponding computer product, i.e. to the product that can be directly loaded in the memory of a computer and comprising portions of software code that allow to implement the method according to the invention when the aforesaid product is run on a computer.

The solution according to the invention allows to group and adequately protect the information regarding the description of the transmitted data, the mechanism for multiplexing the different flows and the mechanism for allocating on multiple transmission channels, all minimising the quantities of bit required in addition to the useful stream (payload) that is transmitted.

The invention can be used with particular advantage to transmit, in real time, audio and/or video signals (possibly accompanied by data signals) on telephone lines, such as lines of a mobile telecommunication network, such as a cellular network.

The reference to said context of application, however, must not be construed to limit the field of possible application of the invention, which is quite general.

### BRIEF DESCRIPTION OF DRAWINGS

The invention will now be described, purely by way of non limiting example, with reference to the accompanying drawings, an which:

FIG. 1 shows, in the form of a functional block diagram, the operation of a system according to the invention, considered from the transmission side, and

FIG. 2 shows, in the form of a functional block diagram, the operation of a system according to the invention, considered from the reception side.

### BEST MODE FOR CARRYING OUT THE INVENTION

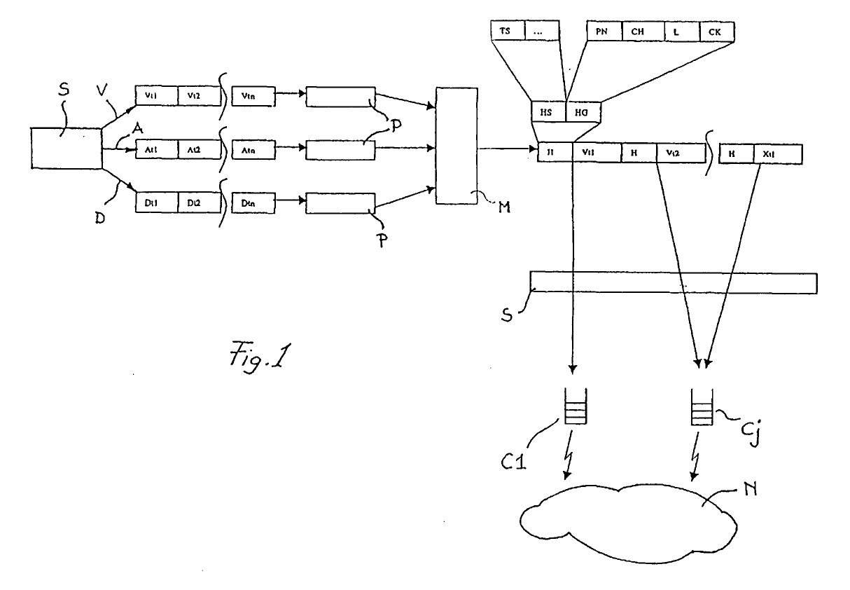

In the diagram of FIG. 1, the reference number S generally indicates a source of video V, audio A and/or data D information streams that are presupposed to be assembled in access units of variable size, each associated to a certain corresponding meta-information.

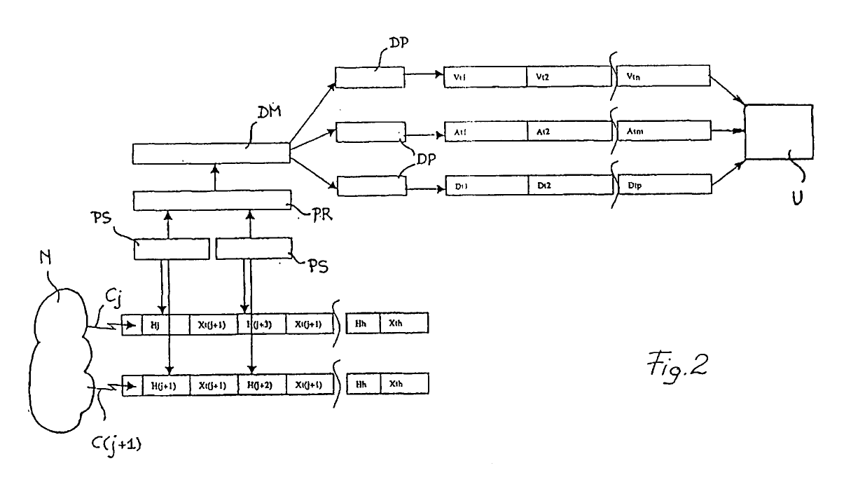

The meta-information includes, in particular, a so-called “time stamp” indicating the time instant whereto the access unit is referred (for instance the instance when a video frame is captured), measured in relation to a time reference system that is assumed to be known both to the source S and to a user or recipient U (FIG. 2) of the streams in question.

For instance, in the top left part of FIG. 1 the various access units comprising the video signal V are indicated as Vt1, Vt2, . . . , Vtn. Similarly, the access units of the audio stream A are indicated as At1, At2, . . . , Atn, whilst the homologous units of the data flows D are indicated as Dt1, Dt2, . . . , Dtn. The letters V, A and D identify the nature of the individual information stream (video, audio, data), whilst tn (n=1, . . . n) indicates the time of capture of the corresponding access unit.

The figures of the drawings refer to the presence of three information streams V, A and D. It is nonetheless evident that the present invention can also advantageously be applied in contexts in which, for instance:

only some of the streams V, A, D considered previously are present, and/or

multiple streams of the same type are present, i.e., for instance, multiple video streams, multiple audio streams, etc.

All in any possible and/or combination.

The various access units Vtn, Atn, Dtn are provided to respective packetiser modules P that organise (according to criteria that are known in themselves) the stream of the access units into packets of appropriate dimensions in view of transmission.

Each packet contains at least a segment of access unit, i.e. a segment of access unit, a whole access unit, or yet again a certain number of whole access units.

Each packet is composed by a payload as well as a respective header.

All in view of the aggregation of the various information streams V, A, D into an overall aggregate stream deriving from the aggregating action performed by a module M with multiplexer (mux) function. The aggregate stream is then distributed on a certain number of channels Cj (with j=1, . . . , n: the channel can thus be—at least under certain condition—only one) of a transmission network N, such as a cellular mobile communication network.

The allocating operation on the channels in question is achieved by means of a subdivision or splitter module S that operates according to the specific transmission requirements (for instance, according to the number of channels used at the moment for transmission).

The operating criteria of the multiplexer module M and of the splitter module S are to be considered widely known in the art and such as not to require a detailed description herein, also because such criteria are not relevant, in themselves, for purposes of understanding and implementing the present invention.

As is better illustrated in the top right part of FIG. 1, the individual header associated to the various access units of the streams V, A and D groups two types of fields.

A first set of fields of the header H (set indicated as HS) conveys information specifically configured for the individual stream and which represent the meta-information associated to the transmitted data.

A second set of fields of the header H (set indicated as HG) instead comprises general validity fields, which do not depend on the individual stream, including at least a parity bit (checksum).

It will be noted that, for the sake of illustrative simplicity, the aforesaid sets of fields HS and HG are shown in the figures to be mutually contiguous. Actually, the fields of the two sets in question are usually mutually “mixed”, said solution being preferred, in fact, for example due to parsing requirements upon reception.

Persons skilled in the art will appreciate that the technique for representing the meta-information associated to the individual access unit is taken from the specification of the SL header (ISO/!EC 14496-1), since said specification allows to minimise bit consumption in each header and at the same time is configurable and hence allows for a considerable degree of flexibility.

The specification ISO/IEC 14496-1 provides a precise mechanism for configuring the header SL: this mechanism consists of the preventive transmission of a structure called SLConfigDescriptor which establishes, for instance, how many bits are to be used to represent a time stamp, and in what scale.

In the solution according to the invention a structure like SLConfigDescriptor can be transmitted preventively, but also be pre-set on the terminals. In any case additional configuration parameters are added to said SLConfigDescriptor in order to handle the case of multiple access units in a single packet.

The technique used in this case is similar to the one defined for the packetisation of MPEG-4 streams on RTP (current reference: IETF draft-gentric-avt-mpeg4-multiSL-04.txt).

Overall, the set of fields used for conveying into the header H the meta-information of the access units composes the header part called HS herein. Each individual stream in general needs its own configuration relating to the header HS whilst the configuration parameters can be different for each stream.

As stated previously, in addition to the fields of the set HS, the header contains further information, globally indicated as HG, destined to allow the subdivision of the transported stream on the different lines and the correct re-assembly at the receiver.

In particular, in the embodiment illustrated herein, the set of additional information HG comprises the following fields:

PN: number of the packet in the order it was sent on the transmission system,

CH: channel identifier; each channel carries a particular stream (video, audio or data),

L: length of the data packet,

CK: protection checksum for all the data of the header (thus, both of the HS part and of the HG part), except for CK itself.

In a preferred manner, the field CH with the channel identifier is situated in a front position of the header H, to precede the set HS, for obvious parsing requirements in reception.

The size (number of bits) used for the various fields of the header HG is determined in such a way as to obtain the best compromise between the reduction of the overhead introduced by the generation of the header and the performance required from the system.

The configuration of the part of header HG cannot be established at run-time (as can be hypothesised for the part HS), but instead represents a constraint for the transmitter-receiver system.

The assignment of different channels CH available to the various video, audio and data streams can be pre-set or be established at run-time; in the latter case, however, it is necessary to reserve a channel for the assignment.

In the definition of the data that comprise the two sets of fields of the header H, it is necessary to take into account some intrinsic factors linked to the general characteristics of the transmission system.

For example, the length of the time stamp field in HS determines the wrap-around time of the time stamp.

Similarly, the maximum value of the field PN in HG determines the maximum difference in travel time allowed between available lines.

The length of the field CH determines the maximum number of streams that can be supported at the same time and, similarly, the maximum value of L corresponds to the maximum length of the packet.

Lastly, the length of the field CK determines the error detection/correction capacity for the headers.

Packets are generated with variable length, in particular with a maximum size that allows to balance with a certain precision the distribution of the data on the multiplicity of available channels. The packets thereby generated are distributed by the splitter module S on the various channels C1, . . . , Cj respecting a criterion of homogeneous distribution of the load among the different lines.

Each generated packet is sent on a determined line. Excessively long packets could generate an unbalance in the load of the lines; therefore, the access units whose length exceeds the maximum packet size are fragmented over multiple packets.

The field CH is used during the reception phase for the reconstruction of the various streams of access units V, A and D.

The packet number field PN is destined to allow to reconstruct, during the reception phase, the correct sequence of the packets, thereby overcoming the possible difference in travel time over the transmission network N which may exist among the different channels.

The time stamp and the different other fields of the set HS are destined to allow to reconstruct, during the reception phase, the exact contours of the access units and the meta-information associated thereto, allowing their correct management (for instance, the synchronised reproduction of audio and video).

Examining the structure of the receiver as shown in FIG. 2, it will be noted that the packetised data incoming from the network N on the various channels Cj, . . . C(j+1) are subjected to a series of analysis, reorganisation and buffering operations destined to reconstruct the sequence of access units originally transmitted, maintaining the meta-information that characterise them.

The data received on each individual channel do not expose, in reception, the borders of the individual packets transmitted, but constitute a continuous stream of bytes.

The first step that is executed in the receiver consists, therefore, of analysing the incoming stream of bytes and of identifying the borders of the different packets.

This occurs through modules PS that search the packets analysing the incoming stream of bytes on each channel, seeking a sequence of at least two syntactically correct headers.

In particular, the modules PS try to decode a header (H1) starting from a certain byte in the stream and to verify whether the checksum CK is correct. If so, the modules PS then analyse the next header (H2) which should be located at a distance L (just obtained from the corresponding field of the part HG of H1). If H2 is also found to have a correct checksum CK, the modules PS verify the subsequent headers H3, H4, etc.

The number of headers to be checked can be set selectively.

If the check fails, the modules PS repeat the same type of calculation starting from the byte immediately following the one considered previously, and so on until the frame of the packets is identified.

The modules PS perform a parsing function directed to the interpretation and recognition of the various fields of the headers H.

The packets thus identified by the modules PS are sent to a module PR that re-sorts the packets coming from the different channels, using the conveyed information of the fields PN.

This takes place through a comparison between the head packets in the various active queues. The correct sequence of the packets is thus reconstructed in a manner that is independent from the time of travel that the various packets may have undergone during the delivery.

The third processing step carried out within the receiver provides for a de-multiplexer module DM to allocate (according to the content of the fields CH) the information stream received into a plurality of streams forwarded to an array of de-packetiser modules DP, each tasked with de-packetising a respective information stream.

Each of the de-packetisers DP extracts from each re-sorted packet of the respective information stream (V, A or D) the actual payload and the meta-information associated thereto (conveyed through the part of header HS). Each module PS therefore generates at its output the sequence of the video (Vtn), audio (Atn) or data (Dtn) access units whereon it has cognisance. All in view of the subsequent processing of the respective data, carried out according to known criteria.

Naturally, the principle of the operation holding true, the construction details and the embodiments can be widely varied with respect to what is described and illustrated herein, without thereby departing from the scope of the present invention.

1. Method for transmitting on a set of communication channels (Cj) at least an information stream (V, A, D) assembled in access units (Vtn, Atn, Dtn) with associated respective meta-information, characterised in that for the transmission of said set of channels (Cj) said at least one information stream (V, A, D) is arranged in packets, each packet comprising at least a segment of one of said access units (Vtn, Atn, Dtn) of said at least one information stream (V, A, D) and a header (H); said header (H) comprising:
a first set of fields (HS), which represents the meta-information associated to said at least one segment of said access unit (Vtn, Atn, Dtn) of said at least one information stream (V, A, D), and
a second set of fields (HG) comprising general validity fields, independent from said at least one information stream (V, A, D).

2. Method as claimed in claim 1, characterised in that said access units (Vtn, Atn, Dtn) have variable size.

3. Method as claimed in claim 1 or claim 2, characterised in that said at least one information stream is selected within the group constituted by a video information stream (V), an audio information stream (A), and a data information stream (D).

4. Method as claimed in any of the previous claims, characterised in that said access units (Vtn, Atn, Dtn) relate to mutually different information streams.

5. Method as claimed in any of the previous claims, characterised in that said second set (HG) of fields of said header (H) comprises at least a field selected within the group constituted by the following fields:
number of the packet in the order of sending in transmission (PN),
identifier of the transmission channel (CH),
length of the data packet (L),
check (checksum—CK).

6. Method according to claims 1 to 4 characterised in that said second set (HG) of fields of said header (H) comprises all the following fields
number of the packet in the order of sending in transmission (PN),
identifier of the transmission channel (CH),
length of the data packet (L),
check (checksum—CK).

7. Method as claimed in claim 5 or claim 6, characterised in that said identifier field of the transmission channel (CH) is situated, within said header (H), in a position preceding said first set of fields (HS).

8. Method as claimed in any of the claims 5 through 7, characterised in that said check field (CK) relates to data included both in said first set (HS) and in said second set (HG) of fields of said header (H).

9. Method as claimed in any of the claims 5 through 7, characterised in that said check field (CK) relates to data included both in said first set (HS) and in said second set (HG) of fields of said header (H except the check field (CK) itself.

10. Method as claimed in any of the claims 5 through 9, characterised in that said check field (CK) is a parity check or checksum field.

11. Method as claimed in any of the claims 1 through 10, characterised in that said first set (HS) of fields of said header (H) comprises a time stamp field (TS).

12. Transmission system configured to operate with the method as claimed in any of the claims 1 through 11.

13. Transmitter for a transmission system operating with the method as claimed in any of the claims 1 a 11, characterised in that it comprises:
a multiplexer (M) for generating said information stream arranged in packets starting from said access units (Vtn, Atn, Dtn), and
a splitter module (S) for distributing said information stream arranged in packets on the channels of said set (Cj).

14. Transmitter as claimed in claim 13, characterised in that said splitter module (S) is configured to distribute said information stream arranged in packets in substantially homogeneous fashion on said channels of said set (Cj).

15. Receiver for a transmission system operating with the method as claimed in any of the claims 1 a 11, characterised in that it comprises at least a module for searching the packets (PS) starting from said information stream; said search module being configured in such a way as to:
identify a given byte in said information stream arranged in packets, e
decode said header (H) starting from said given byte.

16. Receiver as claimed in claim 15, for receiving streams arranged in packets comprising, in the second set (HG) of fields of said header (H) a check field (CK), characterised in that said search module (PS) is configured to verify the correct decoding of said header (H) according to said check field.

17. Receiver as claimed in claim 15 or claim 16, characterised in that said search module (PS) is configured in such a way that, in the impossibility of correctly decoding said header (H) starting from said given byte, the search module (PS) repeats the attempt to decode said header (H) starting from a successive byte in the stream.

18. Receiver as claimed in any of the claims 15 through 17, for receiving streams arranged in packets in which said second set (HG) of fields of said header (H) comprises an identifier field (L) of the length of the packet, characterised in that said search module (PS) is configured in such a way that, after the correct decoding of said header (H) in said stream arranged in packets, the search module (PS) analyses a successive header located, in said stream arranged in packets, at an inferred distance form said packet length field (L).

19. Receiver as claimed in any of the claims 15 through 18, characterised in that it comprises, downstream of said at least one search module (PS), a module for re-sorting the packets (PR), said re-sorting module (PR) being configured to sort the packets in said stream according to the order of sending in transmission.

20. Receiver as claimed in claim 19, configured to operate on streams arranged in packets in which said second set (HG) of fields of said header (H) comprises a field indicating the number of the packet in the order of transmission (PN), characterised in that said re-sorting module is configured to operate according to the information inferred from said packet number field (PN).

21. Receiver as claimed in any of the claims 15 through 20, characterised in that it further comprises a de-multiplexer module (DM) for de-aggregating, starting from said stream arranged in packets, respective distinct information streams (V, A, D).

22. Computer product able to be loaded in the memory of a computer, comprising portions of software code for implementing the method as claimed in any of the claims 1 through 11 when said product is made to run on a computer.
